(19) United States
(12) Patent Application Publication
(10) Pub. No.: US 2008/0060924 A1
(43) Pub. Date: Mar. 13, 2008

(54) NON-TOUCHING LIMIT SWITCH

(76) Inventor: YU-TSANG CHI, Taipei (TW)

Correspondence Address: CHI, YU-TSANG, 235 Chung - Ho, Box 8-24, Taipei, 235, omitted

(21) Appl. No.: 11/839,526

(22) Filed: Aug. 15, 2007

(30) Foreign Application Priority Data
Sep. 13, 2006 (TW) 095216348

(51) Int. Cl. H01H 25/00

(52) U.S. Cl. 200/337

(57) ABSTRACT

A non-touching limit switch comprises: an electronic sensor base having an upper housing, an aligning chip, an electronic sensor unit, and a lower housing; wherein the electronic sensor unit and the aligning chip are embedded within a hollow housing resulted from joining the upper housing with the lower housing, and a through opening is disposed at a lateral side of the hollow housing for allowing an extended portion of a control base to connect to; a control base comprising a shaft-cover bracket and a sensing and aligning portion; wherein the shaft-cover bracket is fitted into the through opening of the electronic sensor base, and the sensing and aligning portion is connected to a trigger source via a sensing component.

### FIELD OF THE INVENTION

The invention is directed to a non-touching limit switch, which uses an electronic sensor to control the switch; when an end of a sensing component contacts a trigger source, an electronic sensor unit carries out a sparkless trigger via magnetic induction, thus resulting in a safe and non-touching limit switch.

### DESCRIPTION OF PRIOR ART

Conventionally, the touching limit switches are the primary means used for controlling trigger reactions at a fixed point; the touching limit switches of prior arts usually employ touching switches consisted of trigger plates to control the trigger reactions in electromechanical devices, though in factories where sparks must be carefully avoided like chemical plants, clean rooms, or plants for producing flammable substance, works have to strive to prevent even the tiniest sparks and any strokes that may generate sparks from occurring. Referring to FIG. 1, which shows that within a conventional touching limit switch 1, an expandable spring 4 presses against a two-stage trigger plate 3, and allows the two-stage trigger plate 3 to press against a signal juncture 2 and make it conductive. However, when the trigger plate 3 moves back and forth many times, the point of junction in the signal juncture 2 is prone to produce a small amount of sparks, and once the point of junction in the signal juncture 2 becomes worn over time, relatively more sparks are produced as a result, which will lead to damage and malfunction of the limit switch 1.

### SUMMARY OF THE INVENTION

In light of the aforesaid problems, the primary objective of the invention is to propose a non-touching limit switch that may be used in combination with control switches applied in different work environments, wherein an electronic sensor unit is used to carry out a sparkless trigger via magnetic induction, thus resulting in a safe and non-touching limit switch.

To achieve above object, the present invention provides a non-touching limit switch, comprising: an electronic sensor base being comprised of an upper housing, an aligning chip, an electronic sensor unit, and a lower housing; wherein the electronic sensor unit and the aligning chip are embedded within a hollow housing resulted from joining the upper housing with the lower housing, and a through opening is disposed at a lateral side of the hollow housing for allowing a pivot ring of a control base to connect to; a lateral side of the electronic sensor unit has a sensor gate and an indicator disposed thereon, and the sensor gate corresponds to the through opening of the lower housing; and a control base comprising a shaft-cover bracket and a sensing and aligning portion; wherein the shaft-cover bracket has a pivot ring disposed on an end thereof, and the pivot ring has a cylindrical piston disposed therein; the pivot ring is fitted into the through opening of the electronic sensor base, and the cylindrical piston is fitted through the through opening of the electronic sensor base, so as to be correspondingly coupled to the sensor gate of the electronic sensor unit; another end of the shaft-cover bracket has a sensing and aligning portion disposed thereon, and the sensing and aligning portion has sensing components connected to a trigger source.

### BRIEF DESCRIPTION OF DRAWINGS

The structure and the technical means adopted by the present invention to achieve the above and other objectives can be best understood by referring to the following detailed description of the preferred embodiments and the accompanying diagrams, wherein:

FIG. 1 is a three-dimensional view that shows a conventional touching limit switch that utilizes a trigger plate;

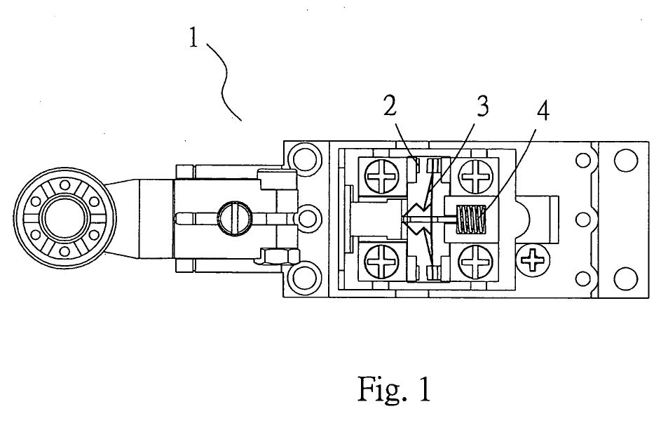

FIG. 2 is an exploded view that shows a non-touching limit switch according to the invention;

FIG. 3 is a three-dimensional view that shows a non-touching limit switch according to the invention;

FIG. 4 is a schematic view that shows the combination of an electronic sensor base with a control base according to a preferred embodiment of the invention (before action);

FIG. 5 is a schematic view that shows the combination of an electronic sensor base with a control base according to a preferred embodiment of the invention (after action);

FIG. 6 is a schematic view that shows the control base being combined with a variety of sensing components according to the invention.

### DETAILED DESCRIPTION OF PREFERRED EMBODIMENTS

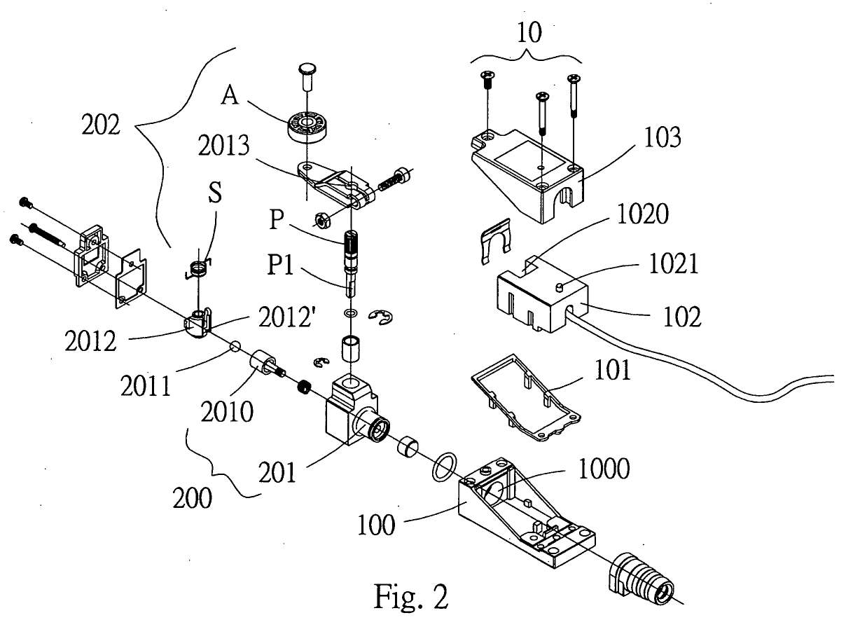

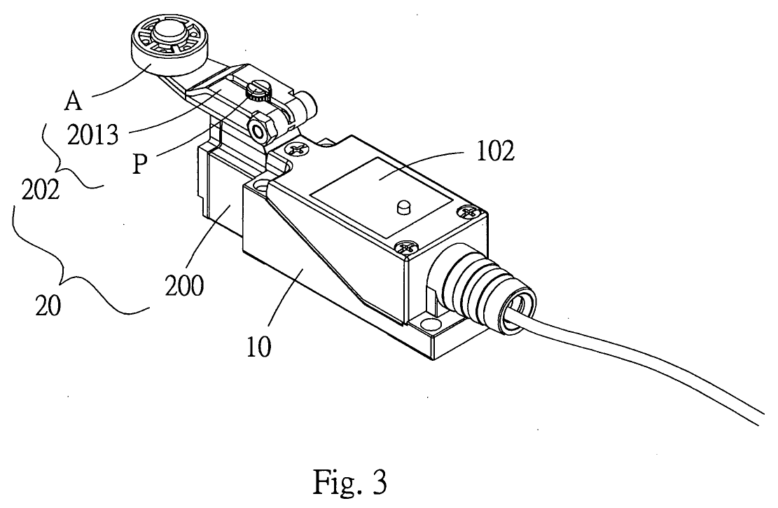

Referring to FIGS. 2 and 3, which show a non-touching limit switch according to the invention, comprising:

an electronic sensor base 10 that is comprised of an upper housing 100, an aligning chip 101, an electronic sensor unit 102, and a lower housing 103; wherein the electronic sensor unit 102 and the aligning chip 101 are embedded within a hollow housing resulted from joining the upper housing 100 with the lower housing 103, and a through opening 1000 is disposed at a lateral side of the hollow housing for allowing a pivot ring 201 of a shaft-cover bracket 200 in a control base 20 to connect to; a lateral side of the electronic sensor unit 102 has a sensor gate 1020 and an indicator 1021 disposed thereon, and the sensor gate 1020 corresponds to the through opening 1000 of the lower housing 103, while the indicator 1021 is used to indicate status of magnetic induction;

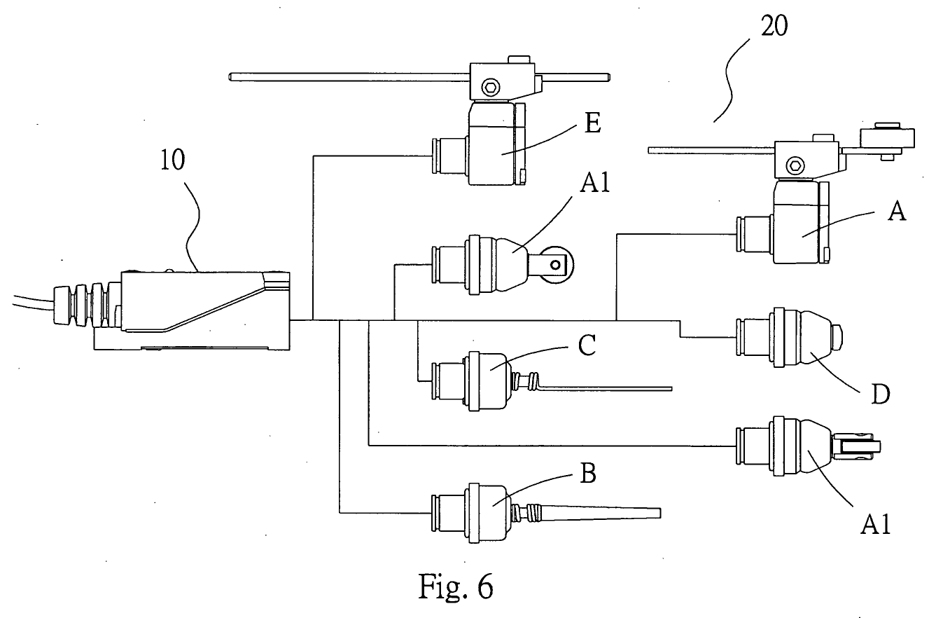

a control base 20 comprising a shaft-cover bracket 200 and a sensing and aligning portion 202; the shaft-cover bracket 200 is fitted through the through opening 1000 of the electronic sensor base 10, and one end of the shaft-cover bracket 200 has a pivot ring 201 disposed thereon, while the pivot ring 201 has a cylindrical piston 2010 disposed therein; the pivot ring 201 is fitted into the through opening 1000 of the electronic sensor base 10, and the cylindrical piston 2010 is fitted through the through opening 1000 of the electronic sensor base 10, so as to be correspondingly coupled to the sensor gate 1020 of the electronic sensor unit 102; another end of the shaft-cover bracket 200 has a sensing and aligning portion 202 disposed thereon, wherein the sensing and aligning portion 202 is comprised of an aligning ball 2011, an aligning yoke 2012, a linking component 2013, and a sensing component 2014; in which an end of the aligning yoke 2012 presses against the aligning ball 2011, and the aligning ball 2011 comes into contact with the cylindrical piston 2010, while another end of the aligning yoke 2012 is connected to one linking component 2013, and an end of the linking component 2013 is connected to one sensing component 2014; the sensing component 2014 may be selected from the group consisting of a guiding wheel A or A1, a trigger rod B, a micro rod C, a top cone D, and a guiding rod E or E1; as shown in FIG. 6, and the sensing component 2014 is connected to the trigger source (not shown). The shaft-cover bracket 200 is used to transfer movements of the trigger source (not shown) to the cylindrical piston 2010 and make the cylindrical piston 2010 move linearly, via the linking component 2013 and the aligning yoke 2012; the combination between the sensing and aligning portion 202 and the shaft-cover bracket 200 gives rise to a control base 20;

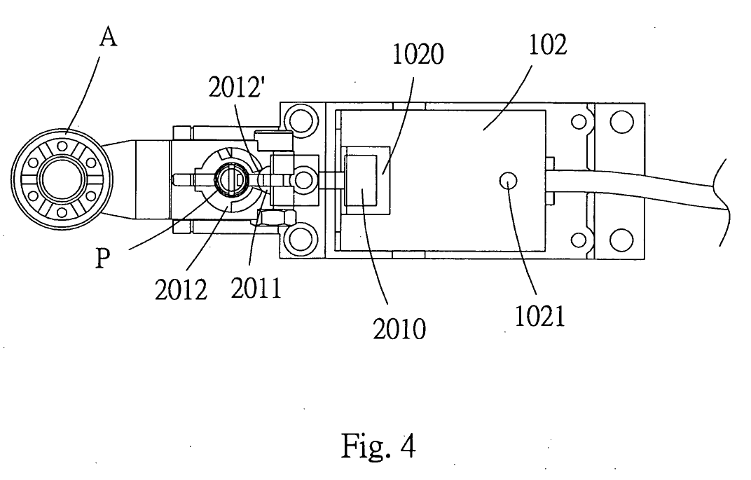

Referring to FIG. 4, which shows the combination of the electronic sensor base with a control base 20 according to a preferred embodiment of the invention. When the trigger source (not shown) has not yet touched the sensing component 2014 (which is a guiding wheel A in this example), and the linking component 2013 has a pin P fixed at an end thereof; a flattened portion P1 formed at an end of the pin P is connected to the aligning yoke 2012, and a retaining spring S fitted thereon is kept loose. The aligning ball 2011 is rollingly disposed in a recess 2012′ of the aligning yoke 2012, so as to prevent the cylindrical piston 2010 from moving around, and the indicator 1021 at an end of the electronic sensor unit 102 is kept switched off.

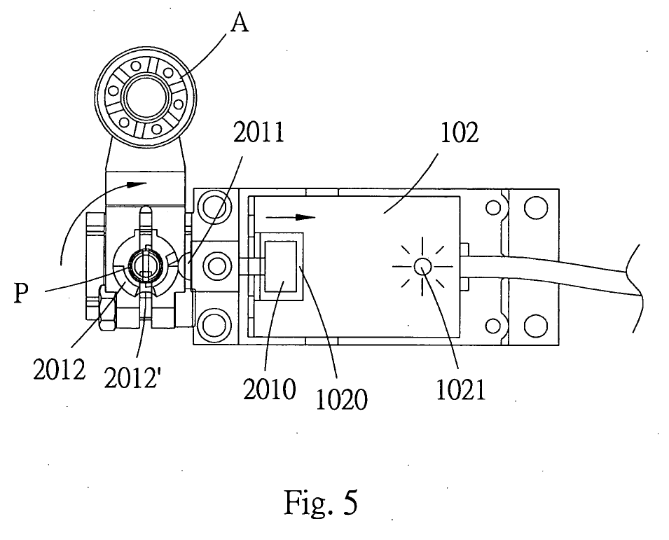

Referring to FIG. 5, which shows when the trigger source (not shown) has touched the sensing component 2014, and the pin P fixed at an end of the linking component 2013 makes the flattened portion PI formed at an end of the pin P connect to the aligning yoke 2012, and the retaining spring S fitted thereon is kept tightened. The aligning ball 2011 is rollingly disposed in the recess 2012′ of the aligning yoke 2012, and a periphery of the aligning yoke 2012 presses the cylindrical piston 2010 to move along the sensor gate 1020 of the electronic sensor unit 102; while the indicator 1021 at an end of the electronic sensor unit 102 is kept switched on, and actuates magnetic induction of the electronic sensor unit 102;

The non-touching limit switch of the invention has following advantages:
1. The limit switch actuates triggers via magnetic induction and prevents sparks from forming, which enhances the security of the limit switch.
2. The limit switch actuates triggers without relying on any touching points, which increases the lifespan and stability of the limit switch.

In sum, the limit switch of the invention has achieved the desired effects on the basis of technologies vastly different from that of the prior arts, which has not previously been proposed by anyone of ordinary skills in the art. Moreover, the subject matter of the invention has never been disclosed before this application, which already satisfied requirements for applying new patents in regard to non-obviousness and utility. Therefore, an application for new patent is filed accordingly for the patent examiners to consider.

Although a preferred embodiment of the invention has been described for purposes of illustration, it is understood that various changes and modifications to the described embodiment can be carried out without departing from the scope and the spirit of the invention as disclosed in the appended claims.

What is claimed is:

1. A non-touching limit switch, comprising:
an electronic sensor base being comprised of an upper housing, an aligning chip, an electronic sensor unit, and a lower housing; wherein the electronic sensor unit and the aligning chip are embedded within a hollow housing resulted from joining the upper housing with the lower housing, and a through opening is disposed at a lateral side of the hollow housing for allowing a pivot ring of a control base to connect to; a lateral side of the electronic sensor unit has a sensor gate and an indicator disposed thereon, and the sensor gate corresponds to the through opening of the lower housing; and
a control base comprising a shaft-cover bracket and a sensing and aligning portion; wherein the shaft-cover bracket has a pivot ring disposed on an end thereof, and the pivot ring has a cylindrical piston disposed therein; the pivot ring is fitted into the through opening of the electronic sensor base, and the cylindrical piston is fitted through the through opening of the electronic sensor base, so as to be correspondingly coupled to the sensor gate of the electronic sensor unit; another end of the shaft-cover bracket has a sensing and aligning portion disposed thereon, and the sensing and aligning portion has sensing components connected to a trigger source.

2. The non-touching limit switch of claim 1, wherein the sensing and aligning portion of the control base is comprised of an aligning ball, an aligning yoke, a linking component, and a sensing component; in which an end of the aligning yoke presses against the aligning ball, and the aligning ball comes into contact with the cylindrical piston, while another end of the aligning yoke is connected to one linking component, and an end of the linking component is connected to one sensing component.

3. The non-touching limit switch of claim 2, wherein the sensing component of the sensing and aligning portion may be selected from the group consisting of a guiding wheel, a trigger rod, a micro rod, a top cone, and a guiding rod, and the sensing component is connected to the trigger source.

4. The non-touching limit switch of claim 1, wherein the shaft-cover bracket of the control base is used to transfer movements of the trigger source to the cylindrical piston and make the cylindrical piston move linearly, via the linking component and the aligning yoke.
